(19) United States
(12) Patent Application Publication
(10) Pub. No.: US 2008/0094669 A1
(43) Pub. Date: Apr. 24, 2008

(54) Printer control apparatus

(75) Inventor: Keita Imai, Osaka (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 11/894,982

(22) Filed: Aug. 22, 2007

(30) Foreign Application Priority Data
Aug. 29, 2006 (JP) 2006-232053

(51) Int. Cl. H04N 1/387

(52) U.S. Cl. 358/452

(57) ABSTRACT

There is provided a printer control apparatus that allows a user to easily and properly perform editing works, such as deletion of an undesired image, before printing out a web page or the like displayed by a browser, and thereby helps reduce the consumption of expendable supplies, such as inks, developers or the like. The apparatus is so configured as to include: an image data output unit 108c for outputting an image data to be printed out displayed on a preview display unit as a preview image to a printer; an area designation unit for designating an area for the preview image; an editing operation unit 108b for performing predetermined editing operations for the designated area; and an image editing unit 108a for editing the image to be printed out according to the editing operation.

### BACKGROUND OF THE INVENTION

1. Field of the Invention

The present invention relates to a printer control apparatus having a preview display unit for displaying an image to be printed out as a preview display and an image data output unit for outputting the image to be printed out to a printer.

2. Description of the Related Art

With the spread of the Internet, various people, such as public figures, celebrities, researchers, and spokesmen for companies, as well as individuals, have come to use the Internet to collect and post information. The Internet excels publications and periodicals in variety, promptness and update frequency of information posted thereon, and also has characteristics that no other mass media have, such as easiness and economy in collecting and posting information.

Web pages, on which information on the Internet is usually posted, have banners arranged thereon in many cases. The banners prompt viewers to click their mice and call linked pages in response to the clicks. Banners are, in many cases, composed of color images to attract viewers' attention, and are, in some cases, composed of moving images.

These web pages, on which many pieces of information can be posted, in many cases have attractive formations, containing a number of chromatic color illustrations, photos, and moving images arranged thereon. Even character information is, in many cases, represented by colors other than black.

Information posted on web pages is subjected to an analysis performed by an application for viewing web pages (hereinafter, referred to as a “browser”). The browser analyzes files containing character information or layout information described in HTML (Hyper Text Markup Language) or the like, image files and audio files, which have been obtained from a server or the like on the Internet, and reproduces and displays the information contained in the files on a display on the basis of the layout information. Some browsers are equipped with a framing function that divides a browser's window into a plurality of regions (each region is referred to as a “frame”) and displays different web pages within respective frames.

The browser causes a printer to execute a printout via a printer driver to print out information posted on a web page and displayed on the display. More specifically, the browser, in response to a user's operation via a GUI (Graphical User Interface) for a printout, transmits reproduced and displayed data of the web page to the printer driver. The printer driver converts the displayed data into print data capable of being analyzed by the printer, and transmits the converted data to the printer. The printer performs the printout on the basis of the print data. A number of browsers having the framing function can print out web pages displayed within respective frames on a frame by frame basis in a similar way to that described above.

Many of web pages contain undesired information that a user does not want to print out, such as undesired banners, texts and images, as well as information that the user looks for. Those web pages, when being printed out as they are, cause waste of expendable printout supplies, such as a data recording medium, print inks or developers, and the like, and also take a long time to be printed out. The web pages, containing undesired information represented in chromatic colors, cause waste of chromatic color inks or developers, which are usually more costly than black color ones, and also causes the larger printout image data to be processed than that for an achromatic printout, resulting in a longer printout time.

To reduce the waste of the expendable printout supplies and the printout time, it is desirable to print out only a frame that has been selected from web pages and contains desired information, or to convert the information from its chromatic color representation into an achromatic color one to print out the information. However, it is not possible to print out only the desired information if the web page containing the desired information does not accept the framing function, the browser or printer driver does not provide a function of frame-by-frame printouts, or the frame containing the desired information further contains undesired banners, texts or images. In the last two cases, even a web page that accepts the framing function causes its information represented in chromatic colors to be printed out in the chromatic colors.

The user can copy a web page containing his/her desired information, paste it onto another application, such as image processing or word processing software, edit it, and thereafter print it out. Although this process enables only the desired information to be printed out, or enables the information represented in chromatic colors to be printed out in a converted achromatic color, it requires a remarkably cumbersome work.

Unexamined Japanese Patent Publication No. 200-586771 proposes an image processing apparatus that restricts undesired color printouts to reduce a printout data size and thereby improve an image-forming speed, prevent color inks or the like from being wasted, and reduce image forming costs. The apparatus has a reading unit to read an original image data; a receiving unit for receiving the user's free designation of an image area that is undesired to be output in chromatic colors, such as logos or background marks, within the read original image data; and a processing unit that converts chromatic color pixels within the designated image area into achromatic color ones. The processing unit also can perform the similar conversion for image data and a designated image area received via a network.

The image processing apparatus disclosed in Unexamined Japanese Patent Publication No. 2005-86771, however, only converts chromatic color pixels within the designated image area in original image data read by an image reading unit, such as an image scanner, or in image data transmitted via a network into achromatic color ones. The apparatus, for example, cannot directly process the virtual original only displayed on a display unit, such as a monitor, i.e., the virtual original that is unconverted into an image data capable of being finally printed out. The apparatus, therefore, cannot perform the above-described conversion without cumbersome works including: converting the virtual original into image data capable of being printed out; printing out the converted image data as a real original; and reading the original printed out with a reading unit to generate the original image data.

Since the expendable supplies are already consumed as the printer prints out the original image, the supplies are rather consumed much more. A screen capture function provided by an operating system, which stores an image displayed on a monitor as an image file, can generate an image data from the virtual original. However, when the virtual original cannot fully be displayed on the monitor, the screen capture is required many times, the plural pieces of image data have to be generated by use of an image editing application, and the generated plural pieces of image data have to be linked with one another for the conversion to be performed.

### SUMMARY OF THE INVENTION

It is, in light of the above-described problem, an object of the present invention to provide a printer control apparatus that allows a user to precisely designate any area to be edited even for the virtual original image to be printed out, unconverted into image data for a printout, performs a predetermined process for the designated area, thereby generates print image data capable of controlling or eliminating the consumption of inks, developers or the like, and feeds a printer with the generated print image data.

The printer control apparatus according to one aspect of the present invention is a printer control apparatus including: a preview display unit for displaying an image to be printed out as a preview image; and an image data output unit for outputting the image to be printed out to a printer. The apparatus further includes: an area designation unit for designating an area for the preview image displayed by the preview display unit; an editing operation unit for performing a predetermined editing operation for the designated area; and an image editing unit for editing the image to be printed out according to the editing operation performed by the editing operation unit. The image data output unit outputs the image data edited by the image editing unit.

Preferably, the editing operation unit includes a deletion operation unit for deleting an image of the designated area.

Preferably, the editing operation unit includes a monochromatic image conversion operation unit for converting an image of the designated area into a monochromatic image.

Preferably, the editing operation unit includes a monochromatic binary image conversion operation unit for converting an image of the designated area into a monochromatic binary image.

Preferably, the editing operation unit includes a resolution conversion operation unit for reducing a resolution of an image of the designated area.

### BRIEF DESCRIPTION OF THE DRAWINGS

FIG. 1 is a block diagram showing a structure of a printer control apparatus;

FIG. 2 is an illustration showing a structure of a personal computer and a printer connected with each other;

FIG. 3 is a block diagram showing a hardware structure of the personal computer;

FIG. 4 is an explanatory view showing a display screen of a printout image window;

FIG. 5 is an explanatory view showing a designated area in a displayed preview image;

FIG. 6 is an explanatory view showing an image editing operation screen; and

FIG. 7 is a flowchart showing a procedure of a printing process according to the printer control apparatus.

### DESCRIPTION OF THE PREFERRED EMBODIMENTS

Hereinafter, there will be described a printer control apparatus according to the preferred embodiments of the present invention.

The printer control apparatus according to the present invention is built into a personal computer (hereinafter, referred to as a “PC”) 1.

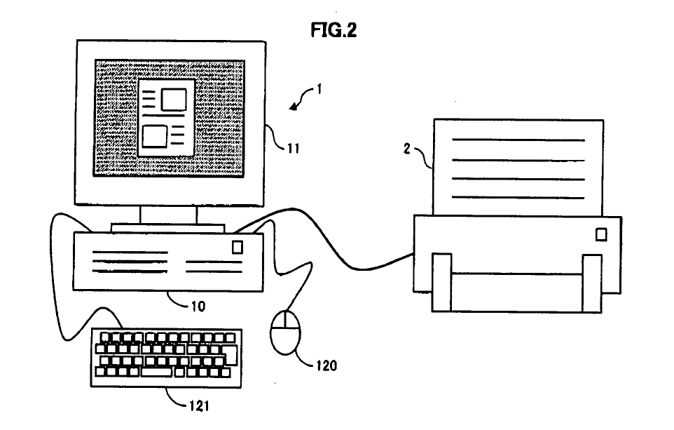

As shown in FIG. 2, the PC 1 includes a PC body 10, a monitor 11 as a display, and a mouse 120 and keyboard 121 each as an input unit 12. The PC body 10 is connected with a printer 2 via a communication cable.

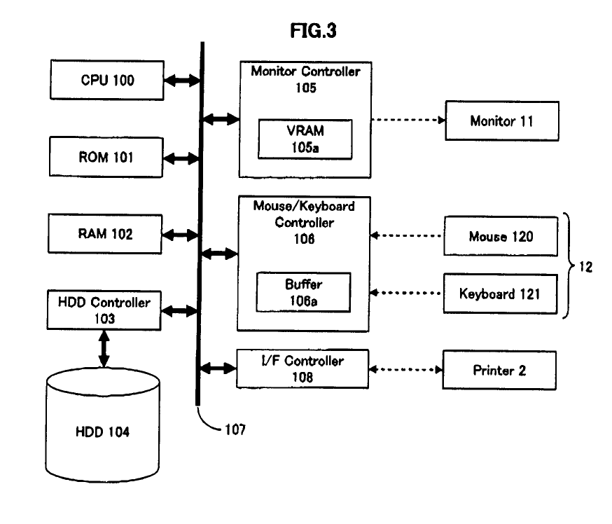

As shown in FIG. 3, the PC body 10 is provided with a CPU 100, a ROM 101, a RAM 102, a hard disk drive hereinafter, referred to as an “HDD”) controller 103, a monitor controller 105, a mouse/keyboard controller 106, an interface controller (hereinafter, referred to as an “I/F controller”) 108 and others, all of which are connected with each other via a bus 107.

The ROM 101 stores a BIOS (Basic Input Output System), which administers hardware resources provided in the PC body 10 and acts as a bridge between an OS (Operating System) and the hardware resources.

The HDD 104, controlled by the HDD controller 103, stores an OS program including interface programs, such as a printer driver for implementing an interface with peripheral devices and various application programs, and allows various data files to be written in and read out.

The OS program and various application programs including a browser are loaded from the HDD 104 into the RAM 102, which is also used as a working area of the CPU 100, and executed by the CPU 100. The printer driver, which is part of the OS program, is executed by the CPU 100, and thereby, the printer control apparatus according to the present invention is implemented. Hereinafter, the function of the OS program or the application programs executed by the CPU is simply referred to as the “OS” or the “application.”

The mouse/keyboard controller 106 includes a buffer 106a for temporarily holding an input signal from the input unit 12, such as the mouse 120, the keyboard 121 and the like. The mouse/keyboard controller 106 is configured to supply the OS with the input signal held in the buffer 106a on a timely basis.

The monitor controller 105 performs a bridging control of signals communicated between the OS and the monitor 11, obtains, from the OS, graphic data corresponding to a content supplied from the application (the graphic data is hereinafter, referred to as “rendering data”), spreads display data to be displayed on the monitor onto a VRAM (Video RAM) 105a provided therein on the basis of the rendering data, and displays an image on the monitor 11 in accordance with the display data rendered onto the VRAM 105a.

The I/F controller 108 obtains, from the OS, the rendering data corresponding to the content supplied from the application, generates rendering commands capable of being interpreted by the printer on the basis of the rendering data or further generates rasterized bitmap data according to the rendering commands, and supplies the printer 2 with the generated commands or data. Thus, the present preferred embodiment implements a functional block as a printer driver by use of the I/F controller 108.

Once the PC body 10 is powered on, the CPU 100 reads out the BIOS from the ROM 101, a start-up driver set up in the BIOS causes the CPU 100 to read out the OS program, thereby the OS starts up, and then the user becomes able to start up application programs.

Once the user operates the input unit 12 to start up the application program, such as the browser, after the OS has started, the OS reads out the application program from the HDD 104 to start up the same. Thus, the application running on the PC 1 is administered and controlled by the OS.

The OS has a window system incorporated therein. A graphic engine in the OS generates the rendering data corresponding to the content generated by the application, such as characters, images and the like. The generated rendering data enables the content to be displayed as a window display on the monitor 11. The image displayed on the monitor 11 is a virtual image of the content unconverted into the image data capable of being finally printed out (an image only for display and small in pixel number).

More specifically, the OS supplies the monitor controller 105 with the rendering data corresponding to the content generated by the application. The monitor controller 105 spreads the display data onto the VRAM 105a on the basis of the supplied rendering data, and controls the monitor 11 for display on the basis of the display data rendered onto the VRAM 105a. As a result, the virtual image corresponding to the content is displayed within a window of the application on the monitor 11.

Once the user operates the input unit 12 to move or delete the window, operation information corresponding to the user's operation is sent to the application via the OS. The application performs a necessary process corresponding to the operation information, causing the monitor 11 to display the results of the process via the monitor controller 105.

Once the user operates the input unit 12 to print out the content displayed in the window, the I/F controller 108 (the I/F controller 108 is regarded as a printer driver in the present preferred embodiment) is started up, and thereby a printing image window is displayed on the monitor 11 via the monitor controller 105. The I/F controller 108 supplies the printer 2 with the printing image data on the basis of the user's printout operation.

The printer control apparatus implemented by the I/F controller 108 has: a preview display unit for displaying an image to be printed out as a preview image; an image data output unit for outputting the image to be printed out to the printer 2; an area designation unit for designating an area for the preview image displayed by the preview display unit, an editing operation unit for performing predetermined editing operations for the designated area; and an image editing unit for editing the image to be printed out according to the editing operation performed by the editing operation unit. The image data output unit outputs the image data edited by the image editing unit to the printer 2.

Thus, the area designation unit enables any area to precisely be designated for the preview image of the image to be printed out, the image editing unit edits the designated area in the image data to be printed out, and the preview display unit displays the image data to be printed out as a preview image, the designated area of which has been edited. The user, therefore, can perform the editing operation, confirming the image data to be printed out.

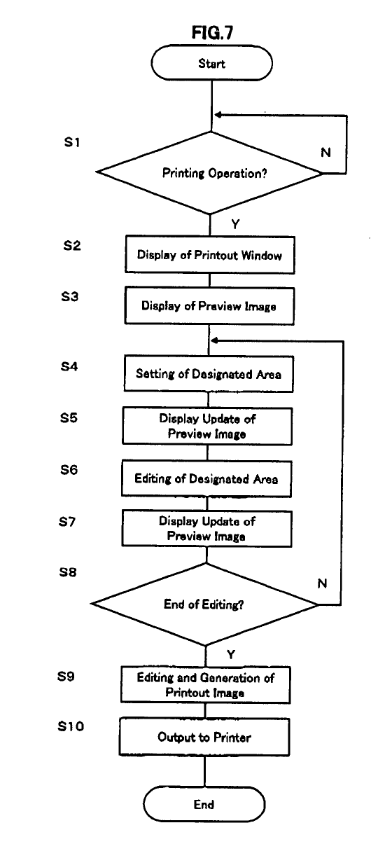

Hereinafter, there will be described a printing process, performed by the printer control apparatus, for the content generated by the application with reference to FIG. 7.

Once the user performs the printing operation via the window of the application (S1), the I/F controller 108 is started up, and thereby the printing image window is displayed on the monitor 11 (S2). Then the preview display unit displays the preview image corresponding to the content in the printing image window (S3).

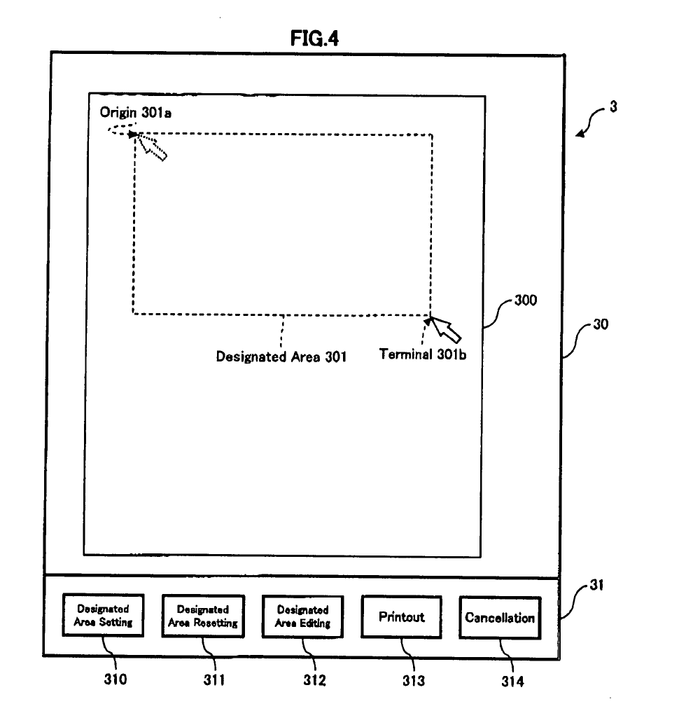

As shown in FIG. 4, a preview image display frame 30 and an editing operation frame 31 are arranged in the printout image window 3. A preview image 300 is displayed in the preview image display frame 30, and a plurality of selection buttons are displayed in the editing operation frame 31.

There are displayed a “designated area setting” button 310, a “designated area resetting” button 311, a “designated area editing” button 312, a “printout” button 313, and a “cancellation” button 314 as the selection buttons in the editing operation frame 31.

Once the user clicks to select hereinafter, simply referred to as “selects”) the “designated area setting” button 310, the user becomes able to set the designated area that is to be an image editing area for the preview image. If the user selects the “designated area resetting” button 311, the designation of the area already set is released.

Further, selecting the “designated area editing” button 312, the user becomes able to edit the image within the designated area. When the “printout” button 313 is selected, the image to be printed out corresponding to the preview image displayed in the printout image window 3 is printed out. When the “cancellation” button 314 is selected, the printout image window 3 is closed and an on-going printout is stopped.

If the user selects the “designated area setting” button 310, points a mouse cursor to any desired position as the origin 301a of an area 301 to be designated and click the mouse, and drags the mouse to any desired position as the terminal 301b of the area 301 to be designated, then a rectangular designated area is set in the preview image 300 (S4).

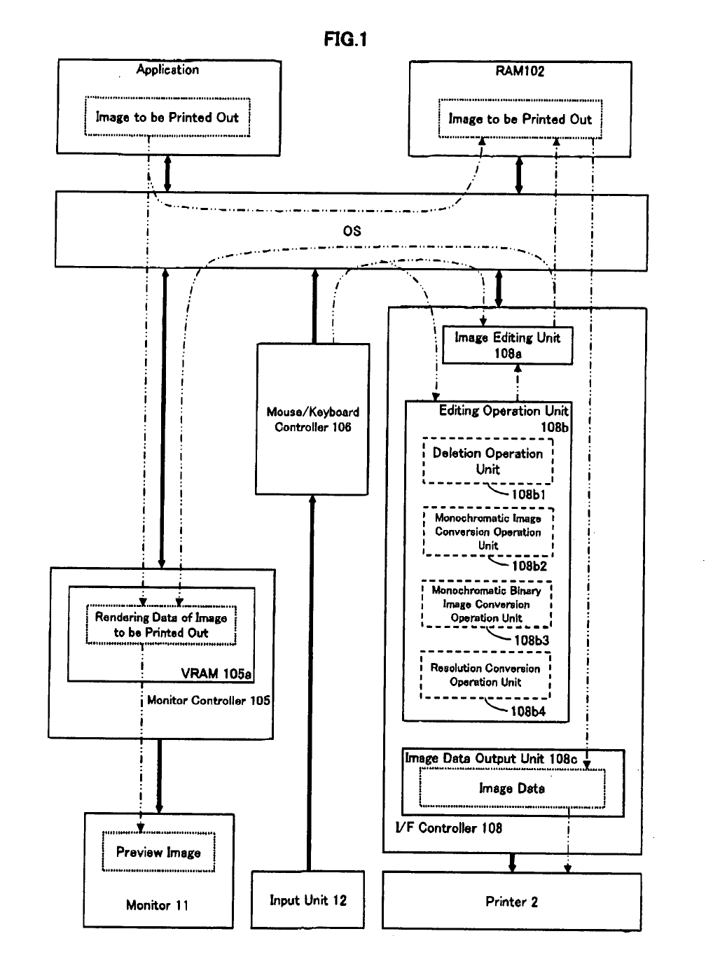

Detailed description will be given as follows. As shown in FIG. 1, the OS receives signals corresponding to the origin 301a and the terminal 301b pointed by the mouse 120 from the mouse/keyboard controller 106, and supplies the I/F controller 108 with the corresponding coordinate data. The I/F controller 108 supplies the OS with editing information to draw a frame of the designated area, and also stores the editing information in the RAM 102. The monitor controller 105 spreads preview image data, to which dashed outline of the designated area is added, onto the VRAM 105a on the basis of the rendering data supplied from the OS, so that the preview image 300 is updated while being displayed on the monitor 11 (S5).

Thus, part of the I/F controller 108, which sets up the designated area 301 on the basis of the coordinate data fed via the mouse/keyboard controller 106, corresponds to the area designation unit, which designates an area in the preview image displayed by the preview display unit.

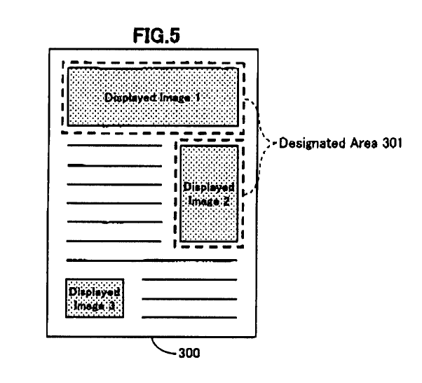

The user, as shown in FIG. 5, can set up a plurality of designated areas 301 in one preview image 300. Each of the designated areas 301 is displayed in the preview image 300 with its outline plotted by dashed lines. If the user selects one of the designated areas 301 to reset the designation, and selects the “designated area resetting” button 311, the selected one of the designated areas 301 will be reset.

Detailed description will be given as follows. As shown in FIG. 1, the OS receives signals corresponding to coordinates within the area, whose designation is to be reset, pointed to by the mouse operation via the mouse/keyboard controller 106, and supplies the I/F controller 108 with the corresponding coordinate data. The I/F controller 108 supplies the OS with a cancellation command to delete the frame of the designated area. The monitor controller 105 spreads preview image data, in which dashed outline of the designated area is deleted, onto the VRAM 105a on the basis of the rendering data supplied from the OS, so that the preview image 300 is updated while being displayed on the monitor 11.

If the user selects the designated area 301 by clicking thereon, and thereafter selects the “designated area editing” button 312, the I/F controller 108 transits to the state that allows image editing of that area.

Detailed description will be given as follows. As shown in FIG. 1, if the user selects the “designated area editing” button 312, the OS supplies the I/F controller 108 with the selection information showing the selection of the “designated area editing” button 312. The I/F controller 108 causes, via the OS and the monitor controller 105, the monitor 11 to display an image editing operation screen used for image editing operation for the designated area. If the user performs the image editing operation for the designated area 301 by operating the image editing operation screen displayed on the monitor 11 (S6), a corresponding editing process is carried out, and thereafter the preview image displayed on the monitor 11 is updated (S7). Thus, the I/F controller 108 has an editing operation unit 108b therein that performs predetermined editing operations for the designated area.

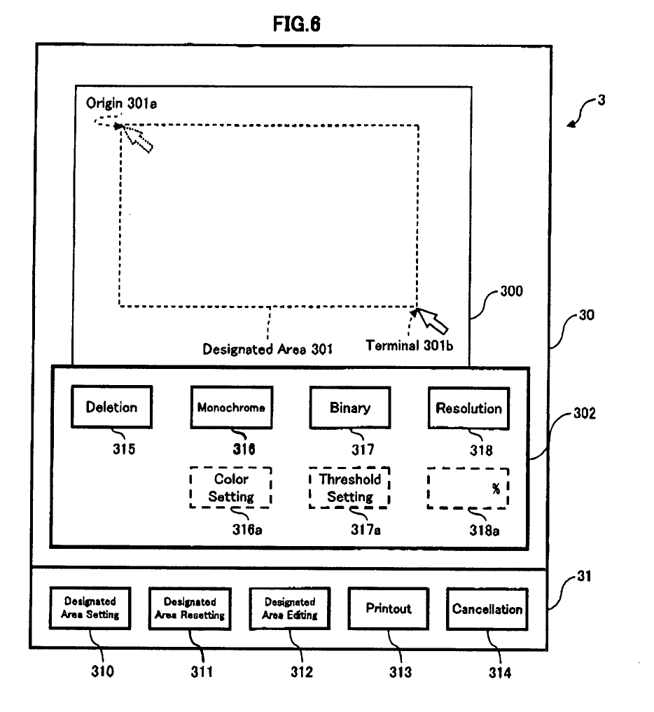

Hereinafter, there will be described an image editing operation for the designated area 301 with reference to FIGS. 1 and 6.

If the user selects the designated area 301 by clicking thereon, and thereafter selects the “designated area editing” button 312, the I/F controller 108 displays, within the preview image display frame 30, the image editing operation screen 302 used for the image editing operation for the designated area 301 that has been selected.

In the image editing operation screen 302, there are displayed a “deletion” button 315, a “monochrome” button 316, a “binary” button 317, and a “resolution” button 318. There are further displayed: a “color setting” button 316a for setting specific colors under the “monochrome” button 316; a “threshold setting” button 317a for setting a threshold used for generating a binary image under the “binary” button 317; and a “thinning ratio setting” field 318a for setting a thinning ratio of pixel data under the “resolution” button 318.

If the user selects the “deletion” button 315, there is generated editing information that deletes the image data of the designated area 301. If the user selects the “monochrome” button 316, there is generated editing information that converts the image data of the designated area 301 into a monochromatic image in a specific color. If the user selects the “binary” button 317, there is generated editing information that converts the image data of the designated area 301 into a monochromatic binary image in a specific color binarized with the set threshold. If the user selects the “resolution” button 318, there is generated editing information that converts the image data of the designated area 301 into image data whose pixels have been thinned out at a thinning ratio set in the “thinning ratio setting” field 318a.

The “color setting” button 316a becomes selectable when the “monochromatic” button 316 or the “binary” button 317 is selected Once the “color setting” button 316a is selected, a color palette is displayed on the monitor 11. A color selected from the color palette by the user is set as the specific color.

The “threshold setting” button 317a becomes selectable when the “binary” button 317 is selected. Once the “threshold setting” button 317a is selected, a threshold setting frame is displayed, and a value written in the threshold setting frame is set as the threshold.

The “thinning ratio” field 318a becomes writable when the “resolution” button 318 is selected. A value written in the “thinning ratio” field 318a is set as the thinning ratio.

If the user selects the “deletion” button 315 to delete the image data of the designated area 301, the I/F controller 108, as shown in FIG. 1, recognizes the selection information via the OS, and stores editing information, which deletes the image data of the designated area 301, in the RAM 102, and also supplies the editing information to the OS. The monitor controller 105 displays an already edited preview image 300 on the monitor 11 on the basis of the rendering data supplied from the OS.

Thus, the I/F controller 108 is provided with a deletion operation unit 108b1 that deletes an image of the designated area. An image data, part of which is deleted as undesired part to be printed out by the deletion operation unit, is supplied from the image data output unit to the printer. In consequence, the data size of the image data to be printed out is advantageously reduced, and thereby an image-forming speed is improved, the consumption of color inks, developers or the like related to the deleted image data is cut down, and image forming costs are reduced.

If the user selects the “monochromatic” button 316 to convert the image data of the designated area 301 into the monochromatic image, the I/F controller 108, as shown in FIG. 1, recognizes selection information via the OS, stores editing information, which converts the image data of the designated area 301 into the monochromatic image in a specific color, in the RAM 102, and also supplies the editing information to the OS. The monitor controller 105 displays an already edited preview image 300 on the monitor 11 on the basis of the rendering data fed from the OS. It is a matter of course that specific color information set by an operation of the above-described “color setting” button 316a is also included in the editing information.

Thus, the I/F controller 108 is provided with a monochromatic image conversion operation unit 108b2 that converts the image in the designated area into the monochromatic image. The monochromatic image is less in data size than an image composed of a plurality of colors. An image data, which contains various colors in the designated area, is converted into the monochromatic image by the monochromatic image conversion operation unit, and is supplied to the printer. In consequence, the image data printed out to the printer can be reduced in data size.

A printout using various colors causes the consumption of costly color inks, developers or the like. However, the conversion into the monochromatic image, if the monochromatic color is set at a color that requires a low price ink, developer or the like, advantageously reduces image-forming costs.

When a printer, for which plurality of inks, developers or the like different in color are provided as an integrated unit, is used for image forming, an exchange period for the unit can be extended if the printing color is set at a color that corresponds to an ink, developer or the like prepared in a large volume.

If the user selects the “binary” button 317 to convert the image data of the designated area 301 into the monochromatic binary image, the I/F controller 108, as shown in FIG. 1, recognizes selection information via the OS, stores editing information, which converts the image data of the designated area 301 into the monochromatic binary image in a specific color, in the RAM 102, and also supplies the editing information to the OS. The monitor controller 105 displays an already edited preview image 300 on the monitor 11 on the basis of the rendering data fed from the OS. It is a matter of course that the threshold set by an operation of the above-described “threshold setting” button 317a is also included in the editing information.

Thus, the I/F controller 108 is provided with a monochromatic binary image conversion operation unit 108b3 that converts the image in the designated area into the monochromatic binary image. The conversion into the monochromatic binary image helps reduce the consumption of inks or developers.

If the user selects the “resolution” button 318 to reduce the resolution of the image data of the designated area 301, the I/F controller 108, as shown in FIG. 1, recognizes selection information via the OS, stores editing information, which reduces the resolution of the image data of the designated area 301, in the RAM 102, and also supplies the editing information to the OS. The monitor controller 105 displays an already edited preview image 300 on the monitor 11 on the basis of the rendering data fed from the OS. It is a matter of course that the above-described thinning ratio is also included in the editing information.

Thus, the I/F controller 108 is provided with a resolution conversion operation unit 108b4 that reduces the resolution of the image in the designated area. The reduction in the resolution of the image in the designated area reduces the data size of the image data to be output to the printer, and in consequence, advantageously reduces the consumption of inks or developers.

If the user completes the image editing operation for the designated area 301 set in the preview image 300 (S8) and selects the “printout” button 313, the I/F controller 108, as shown in FIG. 1, generates rendering commands capable of being interpreted by the printer on the basis of the rendering data fed by the OS and the editing information stored in the RAM 102, or further generates the rasterized bitmap data according to the rendering commands, and stores the generated rendering commands or the bitmap data in the RAM 102 (S9).

Thus, the I/F controller 108 is provided with an image editing unit 108a that edits the image to be printed out according to the editing operation by the editing operation unit 108b.

The bitmap data stored in the RAM 102 by the image editing unit 108a is read out by the image data output unit 108c provided in the I/F controller 108 and supplied to the printer 2 (S10).

If the user selects the “cancellation” button 314, or if the user selects the “printout” button 313, and the I/F controller 108 supplies the printer with the bitmap data, then the printout image window is deleted.

In the printout image window displayed by the I/F controller 108, there are provided printout condition setting tabs used for setting various parameters required for printouts, such as number of printouts, print size and the like, although they are not described in the present preferred embodiment. The user can set various printout conditions by selecting the printout condition setting tabs.

As described above, the printer driver installed in the personal computer 1 runs to implement a printer control method. This method includes; a preview display step of displaying an image to be printed out as a preview image; an image data output step of outputting the image to be printed out to a printer; an area designation step of designating an area for the preview image displayed at the preview display step; an editing operation step of performing predetermined editing operations for the area designated at the area designation step; and an image editing step of editing the image to be printed out according to the editing operations performed at the editing operation step. The image data edited at the image editing step is output to the printer at the image data output step.

The printer driver described above is provided as a computer program product that is stored in a program storage medium, such as a CD ROM, and is to be installed in the HDD 104 of the personal computer 1.

Thus, the computer program product for editing printout image data by use of a computer and outputting the edited image data to a printer includes: a preview display unit for displaying an image to be printed out as a preview image; an image data output unit for outputting the image to be printed out to a printer; an area designation unit for designating an area for the preview image displayed by the preview display unit; an editing operation unit for performing predetermined editing operations for the area designated by the area designation unit; and an image editing unit for editing the image to be printed out according to the editing operations performed by the editing operation unit. The image data output unit outputs the image data edited by the image editing unit.

As described above, the present invention allows a user to easily and properly perform the editing works, such as deletion of an undesired image, before printing out a web page or the like displayed by a browser, and thereby helps reduce the consumption of expendable supplies, such as inks, developers or the like.

Hereinafter, there will be described another preferred embodiment of the present invention. The above-descried preferred embodiment showed such a configuration that the I/F controller 108 includes all of the editing operation units, i.e., the deletion operation unit 108b1, the monochromatic image conversion operation unit 108b2, the monochromatic binary image conversion operation unit 108b3, and the resolution conversion operation unit 108b4. The I/F controller 108, however, does not have to include all of the editing operation units, but may include at least one of them instead.

The above-described preferred embodiment showed such an example that the output image data composed of rasterized bitmap data is output from the image data output unit 108c to the printer 2. The present invention can also be applied to such a configuration that the output image data composed of PDL (Page Description Language) data or the like is output from the image data output unit 108c to the printer 2.

The printer control apparatus according to the present invention can suitably be applied to an electrophotographic printer and an inkjet printer.

It is obvious that any of above-mentioned preferred embodiments is merely an example of the present invention, and the specific configuration of each part thereof can be changed without impairing the function and results of the invention.

What is claimed is:

1. A printer control apparatus comprising:
a preview display unit for displaying an image to be printed out as a preview image;
an image data output unit for outputting the image to be printed out to a printer;
an area designation unit for designating an area for the preview image displayed by the preview display unit;
an editing operation unit for performing a predetermined editing operation for the area designated by the area designation unit; and
an image editing unit for editing the image to be printed out according to the editing operation performed by the editing operation unit, wherein
the image data output unit outputs the image data edited by the image editing unit.

2. The printer control apparatus according to claim 1, wherein
the editing operation unit includes a deletion operation unit for deleting an image of the designated area.

3. The printer control apparatus according to claim 1, wherein
the editing operation unit includes a monochromatic image conversion operation unit for converting an image of the designated area into a monochromatic image.

4. The printer control apparatus according to claim 1, wherein
the editing operation unit includes a monochromatic binary image conversion operation unit for converting an image of the designated area into a monochromatic binary image.

5. The printer control apparatus according to claim 1, wherein
the editing operation unit includes a resolution conversion operation unit for reducing a resolution of an image of the designated area.

6. A printer control method comprising:
a preview display step of displaying an image to be printed out as a preview image;
an image data output step of outputting the image to be printed out to a printer;
an area designation step of designating an area for the preview image displayed at the preview display step;
an editing operation step of performing a predetermined editing operation for the area designated at the area designation step; and
an image editing step of editing the image to be printed out according to the editing operation performed at the editing operation step, wherein
the image data output step outputs the image data edited at the image editing step.

7. A computer program product for editing printout image data by use of a computer and outputting the edited image data to a printer, comprising:
a preview display unit for displaying an image to be printed out as a preview image;
an image data output unit for outputting the image to be printed out to a printer;
an area designation unit for designating an area for the preview image displayed by the preview display unit;
an editing operation unit for performing a predetermined editing operation for the area designated by the area designation unit; and
an image editing unit for editing the image to be printed out according to the editing operation performed by the editing operation unit, wherein
the image data output unit outputs the image data edited by the image editing unit.
